(19) United States
(12) Patent Application Publication
(10) Pub. No.: US 2018/0088036 A1
(43) Pub. Date: Mar. 29, 2018

(54) Method and System for Spectroscopically Measuring Optical Properties of Samples

(71) Applicant: Berthold Technologies GmbH & Co. KG, Bad Wildbad (DE)

(72) Inventors: Frank SCHLEIFENBAUM, Uhldingen-Muehlhofen (DE); Bernd HUTTER, Engelsbrand Salmbach (DE)

(21) Appl. No.: 15/696,226

(22) Filed: Sep. 6, 2017

(30) Foreign Application Priority Data
Sep. 26, 2016 (EP) 16190571.6

(51) Int. Cl. G01N 21/31; G01N 21/63

(52) U.S. Cl. CPC G01N 21/31; G01N 21/63

(57) ABSTRACT

In a method for the spectrally resolved measurement of optical properties of samples, a sample is arranged at a measurement position, and light is generated using a light source. Spectral components of the light are transmitted as excitation light in a first optical path to the sample. Light that has been emitted or transmitted by the sample is transmitted in a second optical path to a detector. A tunable monochromator is arranged in the first optical path and/or in the second optical path. A spectrum of the emitted or transmitted light is recorded over an effective spectral range by shifting a spectral passage range of the tunable monochromator. The method is characterized in that light in the form of light pulses with a specifiable pulse frequency is used. The spectral passage range of the tunable monochromator is shifted at a shifting speed continuously from an initial wavelength to an end wavelength for recording a spectrum. The pulse frequency of the light is synchronized with the shifting speed of the spectral passage range by way of a control such that a plurality of measurements of the emitted or transmitted light takes place within the effective spectral range at a corresponding plurality of spectral support points.

### CROSS REFERENCE TO RELATED APPLICATIONS

This application claims priority under 35 U.S.C. § 119 from European Patent Application No. 16190571.6, filed Sep. 26, 2016, the entire disclosure of which is herein expressly incorporated by reference.

### BACKGROUND AND SUMMARY OF THE INVENTION

The invention relates to a method for spectrally resolved measurement of optical properties of samples, and to a system suitable for performing the method.

In biochemical and pharmacological research and in the clinical field, methods and systems for spectroscopically measuring optical properties of samples which permit characterization of sample properties by way of measuring the fluorescence, the luminescence and/or the absorption are frequently used.

Systems that not only permit fluorescence measurements but also other measurement methods, e.g. luminescence measurements, absorption measurements etc., are frequently referred to as multi-technology readers or multimode readers. In order to be able to perform a large number of measurements within a short period of time, sample multiplex techniques are typically used in which the samples to be examined are arranged in a matrix arrangement in wells of a microwell plate and are examined either sequentially or in parallel. Corresponding apparatuses are usually referred to as microplate readers. Microplate readers are typically set up as multimode readers, with the result that a single apparatus can be used to optionally perform different measurement methods on a large number of samples. If in each case only individual samples are examined, this is often referred to as a cuvette system. Also available are systems that can accomodate and measure both sample arrangements.

During fluorescence measurement, the sample is subjected to excitation light having a specific excitation wavelength by way of a first optical path (typically referred to as the excitation path), and as a result, fluorescent light is generated in the sample. The fluorescent light (emission light) emitted from the sample, which has typically shifted to longer wavelengths (lower energies) as compared to the excitation light, is fed in a second optical path (typically referred to as the emission path) to a detector, with which the resulting intensities are measured. During absorption measurements, the light transmitted by the sample is measured, the intensity of which is lower than that of the excitation light due to absorption in the sample.

If the excitation light originates from a broadband or a polychromatic light source, all wavelengths that are not used for excitation should be suppressed. In highly accurate and sensitive systems, the broadband light from the primary light source is to this end prepared by way of a monochromator in the first optical path. Within the context of this application, the term “monochromator” refers to an optical system for spectral isolation of a specific wavelength or of a limited wavelength range from an incident light intensity with a relatively large spectral bandwidth. A tunable monochromator permits here stepless adjustment of the wavelength to be selected or of the wavelength range to be selected within certain limits. The wavelength range that is in each case transmitted by the monochromator and not blocked is referred to in this application as the “spectral passage range”. In tunable monochromators, the spectral location of the spectral passage range can be set or changed within specific limits. Occasionally, it is also possible for the spectral width of the passage range to be set or changed.

A monochromator can be configured e.g. as a dispersive monochromator or as a filter monochromator or as an interference monochromator.

In a “dispersive monochromator”, incident light is steplessy fanned out or decomposed into its spectral components by way of a dispersive element. A gap aperture is used to select a narrower spectral range around the desired wavelength from this spectrum, wherein the gap width of this gap also determines the bandwidth of the selected light. A dispersive element that can be used is e.g. a prism (acts by way of the dispersion of the prism material) or a diffraction grating (acts by way of diffraction). Some monochromators are configured in the form of what are known as double monochromators, in which the blocking and/or the spectral resolution can be increased as compared to a single dispersive monochromator by way of connecting two dispersive monochromators in series. The width of the spectral passage range in these cases is set by adjusting the gap width of the central gap, and the spectral passage range is changed by way of a concerted movement of the two dispersive elements.

Filter elements such as interference bandpass filters can in principle likewise be used for spectral isolation of a specific wavelength or of a narrow wavelength range from an incident light intensity with a relatively great spectral bandwidth. Known are e.g. steplessly adjustable transmission filter arrangements having at least one spectrally tunable transmission filter, e.g. in the form of a linearly variable filter (LVF). Such arrangements are referred to here as “filter monochromators”. DE 10 2013 224 463 A1 discloses examples of tunable filter monochromators.

An “interference monochromator” utilizes interference effects for wavelength selection. Interference monochromators for example use the multiple reflection of light at mirrors which are arranged in substantially plane-parallel fashion and are partially transmissive for the relevant spectral range. In these arrangements, which are known as Fabry-Perot arrangements, the spectral passage range can be set by changing the mirror distance.

A monochromator is frequently also used for wavelength selection in the emission path. WO 2012/095312 A1 shows an apparatus for measuring optical properties of samples in microplates, which apparatus can also be used for fluorescence measurement and has a dispersive monochromator in the excitation path and in the emission path.

In the methods and systems for spectrally resolved measurement of optical properties of samples that are discussed in this application, a detector is used to record spectra (one or more) of the emitted or transmitted light that is incident on the photosensitive surface of the detector over an effective spectral range of interest. A spectrum contains information relating to properties of the light that is incident on the detector, e.g. its intensity, in dependence on the wavelength or as a function of the wavelength of the light within the effective spectral range.

A distinction is made between two types of spectra, depending on the manner in which they are obtained: if the wavelength of the emitted or transmitted light is kept constant and the wavelength of the excitation light is varied via a tunable monochromator in the first optical path by shifting its spectral passage range, an excitation spectrum is obtained. An emission spectrum (or transmission spectrum), on the other hand, is the result of a scan in which the wavelength of the excitation light is fixed, while the spectral passage range of a tunable monochromator in the second optical path is shifted. If the spectral passage ranges of both monochromators are tuned, this is referred to as three-dimensional spectral scans, by way of which three-dimensional spectra are produced.

For recording a spectrum over a relatively large effective spectral range, the dispersive element in tunable dispersive monochromators is typically rotated relative to the gap apertures in order to shift the spectral location of the spectral passage range and to thus enable successive measurements at different wavelengths of the effective spectral range. EP 2 975 369 A1 here describes the established manner of actuating a monochromator, in which the successive wavelengths are first approached by rotating an optical grating of the monochromator using a first stepper motor, and, once the target position (i.e. the desired wavelength) has finally been reached, the rotational movement is stopped and the measurement is then started. Once the measurement is complete, a discrete rotational movement of the grating is used to move on to the next wavelength of the spectral range, and so on. EP 2 975 369 A1 describes the problem that the inertia in particular of the optical grating has the result that, in the case of quick changes between different alignment positions or rotational angles of the optical grating—in which high acceleration and braking forces occur—high-frequency mechanical vibrations of the optical grating can occur. In order to achieve the desired wavelength precision, it is therefore necessary to accept prolonged waiting times, during which the vibrations decay and then, in the end, only the desired wavelength is incident on the slit aperture which is connected downstream. In order that spectral measurements at different read wavelengths with high precision and short waiting times can still be performed, a proposal is made to insert damping elements of a contactlessly operating eddy current damper in the drive strand between the stepper motor and the optical grating.

It is an object of the invention to provide a method for spectrally resolved measurement of optical properties of samples, which permits high throughput measurements with great precision over relatively short recording times for a spectrum. It is another object to provide a system that is suitable for performing the method.

These objects are achieved by way of a method for the spectrally resolved measurement of optical properties of samples, including: arranging a sample at a measurement position; generating light using a light source; transmitting spectral components of the light as excitation light in a first optical path to the sample; and transmitting light that has been emitted or transmitted by the sample in a second optical path to a detector; wherein a tunable monochromator is arranged in the first optical path and/or in the second optical path; recording a spectrum of the emitted or transmitted light over an effective spectral range by shifting a spectral passage range of the tunable monochromator, wherein light in the form of light pulses with a specifiable pulse frequency is used; the spectral passage range of the tunable monochromator is shifted at a shifting speed continuously from an initial wavelength to an end wavelength for recording a spectrum; and the pulse frequency of the light is synchronized with the shifting speed of the spectral passage range by way of a controller such that a plurality of measurements of the emitted or transmitted light takes place within the effective spectral range at a corresponding plurality of spectral support points. These objects are also achieved by way of a system for the spectrally resolved measurement of optical properties of samples, including: a sample holding device for arranging a sample at a measurement position; a light source for generating light; a detector; a control unit; a first optical path for transmitting spectral components of the light as excitation light to the sample; and a second optical path for transmitting light that has been emitted or transmitted by the sample to the detector; wherein a tunable monochromator which is controllable by the control unit is arranged in the first optical path and/or in the second optical path; wherein the system is set up to record a spectrum of the emitted or transmitted light over an effective spectral range by shifting a spectral passage range of the tunable monochromator, wherein the control unit has an operating mode for recording a spectrum in which the control unit is configured such that the system is controlled such that light in the form of light pulses with specifiable pulse frequency is used; the spectral passage range of the tunable monochromator is shifted at a shifting speed continuously from an initial wavelength to an end wavelength for recording a spectrum; and the pulse frequency of the light is synchronized with the shifting speed of the spectral passage range by way of a control such that a plurality of measurements of the emitted or transmitted light takes place within the effective spectral range at a corresponding plurality of spectral support points. Advantageous developments are specified in the dependent claims. The wording of all claims is made content of the description by way of reference.

It has been found that relatively long recording times can result for a complete spectrum owing to the established way of actuating a tunable monochromator, in which the successive wavelengths are approached in stepwise fashion by the monochromator in start/stop operation, and the measurement is started in each only after the target position has finally been reached. The necessary acceleration and braking ramps during the movement of the gratings or of the filters during the change between consecutive wavelengths give rise to relatively long total measurement times, in particular for high spectral resolution, i.e. in relatively small wavelength steps between successive wavelengths.

The specific disadvantages of start/stop operation with respect to the recording time for a spectrum are avoided in methods and systems in accordance with the claimed invention.

In methods and systems of the claimed invention, light in the form of light pulses having a specifiable pulse frequency is used. As a result, the information contained in the light can be linked in the detector to specific time intervals or measurement times which are short in the manner of pulses.

In order to enable pulsed operation, e.g. the excitation light can be radiated onto the sample in the form of light pulses with a specifiable pulse frequency. To this end, e.g. excitation light in the form of light pulses with a specifiable pulse frequency can be generated by way of a pulsed light source. The system can for this purpose have e.g. a flash lamp, which is controllable at least with respect to the flash frequency. It is also possible to utilize a continuously emitting light source (CW light source) and to divide or chop the emitted light into light pulses before it is incident on the sample by way of a controllable mechanical, electronic or optoelectronic shutter or the like.

It is also possible in principle to continuously irradiate the sample with excitation light and to perform the division into pulses in the second optical path or only at the detector, e.g. using a controllable mechanical, electronic or optoelectronic shutter or the like.

The spectral passage range of the tunable monochromator is shifted at a shifting speed continuously from a starting wavelength to an end wavelength for recording a spectrum. The term “continuously” here means in particular that the shifting speed is not reduced all the way to a standstill during the recording of the spectrum, but that, there is always a finite shifting speed when recording of the spectrum, with the result that the spectral location of the passage range changes all the time. The continuous shifting can be performed with uniform or non-uniform speed.

The shifting should preferably be performed without bumps, i.e. should not exhibit a jump in the speed profile. Irregularities in the speed profile, i.e. jerky movements, should preferably likewise be avoided.

The pulse frequency of the light is synchronized with the shifting speed of the spectral passage range by way of a controller such that a plurality of measurements of the emitted or transmitted light take place within the effective spectral range at a corresponding plurality of spectral support points. The location of the spectral support points in the spectral range here arises substantially from the spectral positions of the spectral passage range at the time of a light pulse, that is to say when e.g. emitting or receiving a light pulse. The effective spectral range extends from the first support point which is of interest for the measurement to the spectrally opposite, last support point which is of interest. Due to the pulsed operation, in combination with the continuous change of the spectral passage range, a synchronized instantaneous observation of a spectral passage range that continuously and steadily changes is achieved.

Synchronization, or synchronized operation, within the meaning of this application is present if the continuous shifting of the passage range, e.g. produced by way of a motor movement, and the pulse generation take place at the same time or in temporally overlapping fashion. The synchronization is in this general case equivalent to ensuring a simultaneity of pulse generation and continuous shifting. The pulse generation and the shifting do not necessarily have to take place in dependence of one another. Pulse generation and shifting can take place in each case freely and without being influenced by one another, as long as there is a temporal overlap.

Synchronization preferably takes place such that one of the two actions, i.e. either the shifting caused e.g. by a motor movement or the pulse generation, takes place at the same time as the other one and, in addition, in dependence thereon. This can be realized for example by way of a motor controller, after travelling a defined number of steps, outputting a signal that causes the pulse controller to generate a pulse in one of the above-described manners. Here, the pulse generation is triggered by the shifting. It can also be realized such that the pulse generation transmits a signal as the motor control from which the latter ascertains the steps to be travelled between two pulses and correspondingly actuates the motor. Here, the shifting is triggered by the pulse generation. It is also possible for the controller to trigger the pulse operation and the shifting in coordinated fashion. In the case of a mutual dependence of pulse generation and shifting, the spectral location of the support points can in each case be specified accurately, as a result of which more precise measurements become possible.

The pulse operation in combination with the continuous changing of the spectral passage range can indeed theoretically result in a slight spectral smear. The order of magnitude thereof, however, is negligible in most cases, or in all practical cases. The theoretical disadvantage is more than made up for by significant achievable advantages (e.g. with respect to the recording time for a spectrum). Other sources of errors which result from a start/stop operation, e.g. vibrations, can be avoided.

For the exemplary quantitative illustration of advantages, a system will be discussed below, which uses, as a light source, a flash lamp and a stepper motor for generating the movement of the adjustable optical element of the tunable monochromator. During the method, the rotation of the grating or the movement of the filter arrangement in the monochromator is synchronized with the flash frequency of the flash lamp during the recording of a spectrum (e.g. absorption spectrum, excitation spectrum or emission spectrum). The motor travel of the stepper motor in the monochromator is continuous. Approaching ramps (from a standstill to a movement) and stopping ramps (until the movement stops) during the spectrum recording within the effective spectral range are dispensed with. Acceleration ramps or braking ramps are provided merely at the beginning and at the end of the spectral scan. During the recording of the spectrum, the spectral passband range or transmission range of the monochromator continuously shifts within the effective spectral range to be examined. The spectral support points are recorded in sync with the light pulses.

In some embodiments, the actuation is performed such that a constant shifting speed of the spectral passage range is present in the selected effective spectral range. As a result, the synchronization, among other things, can be facilitated. The spectrum is then evaluable directly and does not need to be corrected with respect to different distances of the spectral support points.

However, it is also possible that the shifting speed changes, during the continuous shifting of the spectral passage range, between a finite minimum speed and a maximum speed.

In one variant with variable shifting speed, an intensity change of the detected light is ascertained, during the shifting of the passage range, between successive spectral support points, and the shift of the passage range is changed in dependence on the intensity change. It is possible hereby to realize regulation of the shifting speed in dependence on a measured property of the spectrum. The regulation can be effected, for example, inversely proportionally such that spectral ranges with relatively strong intensity changes are travelled with a relatively smaller shifting speed and a correspondingly higher support point density, while spectral ranges with fewer events are travelled more quickly, i.e. with a lower support point density.

It is also possible that, before recording of a spectrum begins, parameters of a speed variation function are preset and the shifting speed is controlled in accordance with the speed variation function. The change in the shifting speed can here be optimized based on previously known properties of an examined spectrum type. Control can be effected, for example, inversely proportionally such that spectral ranges with relatively strong intensity changes are travelled with a relatively smaller shifting speed and a correspondingly higher support point density, while spectral ranges with fewer events are travelled more quickly, i.e. with a lower support point density.

Use of a different number of support points per wavelength interval can also be advantageous for the non-continuous operation (not part of the claimed invention), i.e. for the move-stop-measure operating mode or for start/stop operation. In this case, it is possible for e.g. the step width to be different between immediately successive stopping positions in different wavelength ranges. For example, the step width can be varied in dependence on a previously known or a measured property of the spectrum. This is considered to be an aspect of the disclosure that is independent of the claimed invention and possibly protectable by itself.

A single scan (a single recording of a spectrum) over the effective spectral range can suffice. In some embodiments, provision is made for the recording of a spectrum over the effective spectral range to be repeated at least once with the same synchronization of the pulse frequency with the shifting speed of the spectral passage range, and for the measurement values obtained for each of the recordings to be added in wavelength-correct fashion. It is possible hereby to achieve better measurement statistics at the expense of an increase in the total measurement time.

The invention also relates to a system for spectroscopical measurement of optical properties of samples which is suitable for performing the method.

The tunable monochromator can be configured e.g. as a dispersive monochromator or as a filter monochromator or as an interference monochromator.

Other objects, advantages and novel features of the present invention will become apparent from the following detailed description of one or more preferred embodiments when considered in conjunction with the accompanying drawings.

### BRIEF DESCRIPTION OF THE DRAWINGS

Further advantages and aspects of the invention can be gathered from the claims and from the following description of preferred exemplary embodiments of the invention, which are explained below with reference to the figures.

FIG. 1 schematically shows an exemplary embodiment of a system according to the invention for spectrally resolved measurement of optical properties of samples;

FIG. 2 shows the signal flow between components of the system in a first operating mode;

FIG. 3 shows the signal flow between components of the system in a second operating mode;

FIG. 4 shows a diagram for the connection between the motor speed of an actuating motor that is responsible for adjusting a monochromator and the time or the wavelength corresponding to the time;

FIG. 5 shows a schematic diagram of the dependence of the travel distance of the actuating motor on time in a conventional system with start/stop operation;

FIG. 6 shows a schematic diagram of the dependence of the travel distance of the actuating motor on time in an exemplary embodiment with continuous change of the spectral location of the spectral passage range;

FIG. 7 shows an I(λ) diagram with a hypothetical spectrum of a sample substance, wherein the spectrum is scanned with varying support point density by changing the shifting speed of the spectral passage range within the effective spectral range during the continuous shifting in dependence on the local gradient of the spectrum.

### DETAILED DESCRIPTION OF THE DRAWINGS

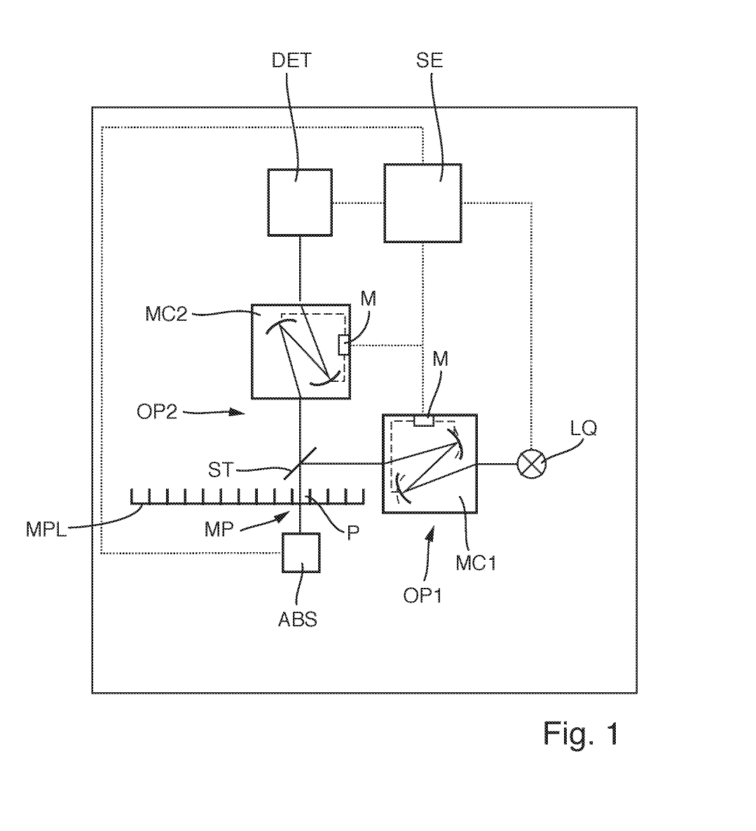

FIG. 1 schematically shows an exemplary embodiment of a system SYS in accordance with the invention for spectrally resolved measurement of optical properties of samples. The system is a component part of a multitechnology reader, which, in addition to the measurement of fluorescence, also permits other measurements, for example the measurement of the absorption in a sample.

The system SYS has a primary light source LQ in the form of a xenon flash lamp. The light source has a broad emission spectrum in the visible spectral range (“white light”). The flash frequency of the light source is settable within specific limits, such that excitation light in the form of light pulses having a specifiable pulse frequency can be generated. The light source LQ is connected to the control unit SE of the system, by way of which the pulse frequency can be set.

A first optical path OP1, also referred to as the excitation path, leads from the light source LQ, via a tunable first monochromator MC1 and a beam splitter arrangement ST connected downstream, to a measurement position MP, at which a sample P is located during system use. The excitation light is radiated into the sample substantially perpendicularly from above. The sample is located in a depression (e.g. a well) of a microwell plate MPL having many wells.

The first monochromator MC1 is a tunable dispersive monochromator connected to the control unit SE. The location of the spectral passage range of the first monochromator MC1 can be adjusted continuously over a large spectral range as a reaction to control signals of the control unit SE.

The optical elements of the first optical path (excitation path) serve for the transmission of spectral components of light from the primary light source LQ as excitation light into the measurement position MP. Located in the sample is a substance that can be excited by the excitation light to emit fluorescent light. The fluorescent light is shifted toward lower energies, or larger wavelengths, with respect to the excitation light. The extent of the spectral red shift is specific to the substance and is referred to as Stokes shift. Information relating to the properties of the sample substance is contained in the spectrum of the emission light.

The emission light passes, via a second optical path OP2 (also referred to as the emission path), from the sample P to a detector DET, which generates electrical signals in dependence on incident light, which are fed to an evaluation unit in order to spectrally evaluate the emission light for characterizing the sample. The evaluation unit can be integrated in the control unit SE.

Located in the second optical path between the beam splitter arrangement ST and the detector is a tunable second monochromator MC2, which is provided for transmitting, from the spectrum of the emission light, only a relatively narrow portion, i.e. a spectral passage range with a specifiable spectral location, to the detector at any one time. The second monochromator MC2 is also connected to the control unit SE, with the result that the spectral location of the passage range can be specified at any time by way of control signals of the control unit.

Arranged below the measurement position MP is an absorption detector ABS, which is likewise connected to the control unit SE. The absorption detector can be used to measure the intensity of emission light which, after excitation of the sample, passes via the first optical path OP1 through the sample and a transparent bottom of the well to the absorption detector.

The first monochromator MC1 in the first optical path and the second monochromator MC2 are in the form of a dispersive double monochromator. A double monochromator of this type has three gaps overall, specifically an entry gap, a central gap, and an exit gap. The central gap is at once the exit gap of a first dispersive monochromator that is connected upstream and the entry gap of a second dispersive monochromator that is connected downstream. Each of the gaps is defined by a corresponding gap aperture in an associated gap plane. The gap width is able to be adjusted in each case in a stepless fashion. It is also possible in other embodiments, for example for cost reasons, for fixed gaps or gap widths to be provided at the entry and/or at the exit.

Provided within the double monochromators are in each case dispersive elements in the form of concave reflection gratings. The reflection gratings are rotatably mounted and can be rotated or pivoted synchronously with one another about mutually parallel rotational axes by way of a stepper motor M. As a result, the spectral passage range of each of the monochromators can be shifted continuously from a starting wavelength to an end wavelength at a shifting speed that is specifiable by the control unit SE for recording of a spectrum.

A synchronization module in the software of the control unit SE can be used to synchronize the pulse frequency of the light source LQ with the shifting speed of the spectral passage range of the first monochromator MC1 and/or of the second monochromator MC2 such that a large number of measurements of the emitted or transmitted light can take place within an effective spectral range of interest at a corresponding large number of spectral support points.

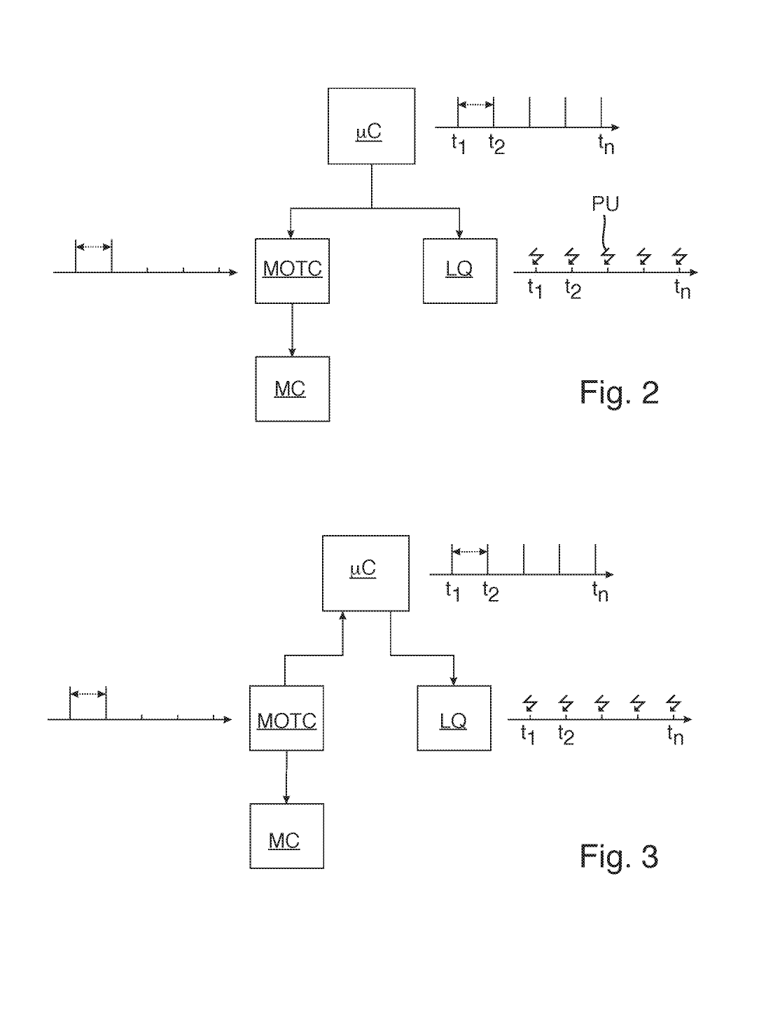

The system SYS can be operated in different operating modes. Two of the operating modes are explained by way of example with reference to FIGS. 2 and 3. These figures each show schematic diagrams for signal transmission between different components of the system. A microcontroller μC of the control unit is connected, in signal-conducting fashion, to the motor controller MOTC of the stepper motor of a monochromator MC, which can be a monochromator in the first optical path or in the second optical path. The microcontroller μC also controls the flash operation of the light source LQ, i.e. the emission of light pulses PU with a specifiable pulse frequency or at specifiable times t₁, t₂ etc. In the first operating mode (of FIG. 2), the microcontroller μC triggers both the light source LQ (flash lamp) and the motor travel of the stepper motor, which controls the rotational movement of the dispersive grating in the monochromator MC and thus the shifting of the spectral passage range. In the second operating mode (of FIG. 3), the motor is operated at a specifiable motor travel speed, and the motor travel speed determines the flash frequency. It is also possible for the light source to be triggered directly via the motor controller. In this case, the motor controller is connected, in signal-conducting fashion, to the light source.

In both operating modes it is possible for the rotational movement of the dispersive grating or the dispersive gratings of a monochromator to be synchronized with the flash frequency of the flash lamp during the recording of an absorption spectrum, an excitation spectrum or an emission spectrum. The motor travel of the motor in this case in the monochromator is continuous (without stops in-between). Stopping ramps and braking ramps are dispensed with during the spectrum recording, and they are provided only at the beginning and at the end of a spectral scan. As a result, the spectral passband range of a monochromator shifts continuously, and spectral support points of the spectrum are recorded in sync with the flash lamp.

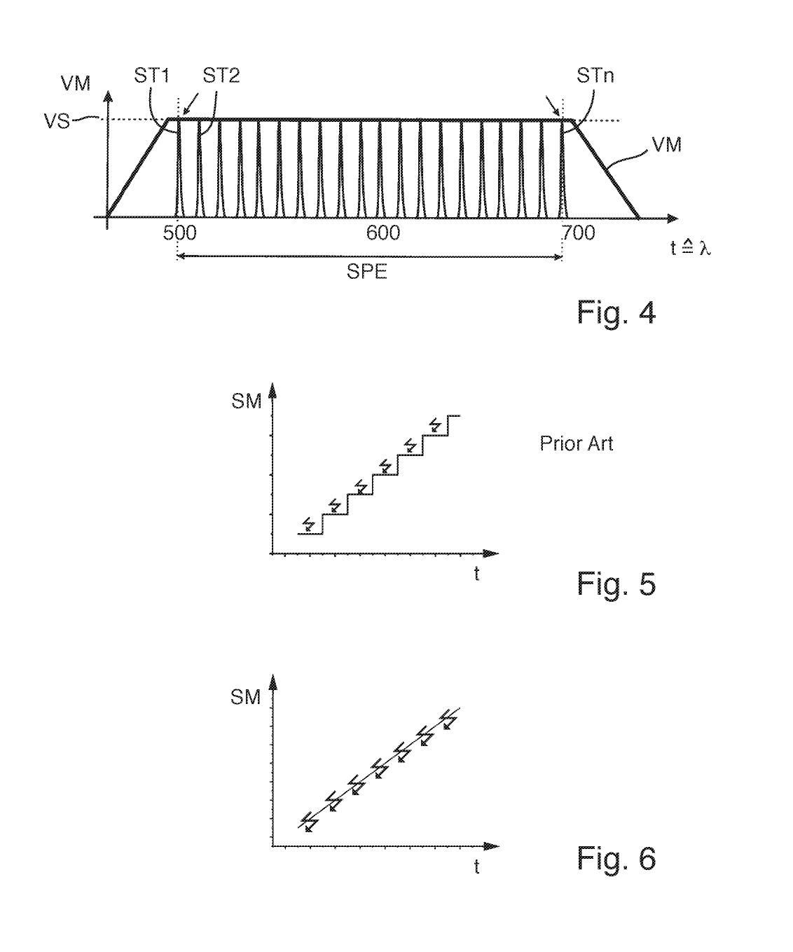

FIG. 4 shows, for illustrative purposes, a schematic diagram that shows the connection between the motor speed VM, plotted on the y-axis, of the stepper motor M responsible for adjusting the monochromator as a function of time t (solid line). At times t₁, t₂ etc., the light source LQ emits in each case one flash or light pulse. Since the spectral location of the spectral passage range of the monochromator is adjusted using the stepper motor M, the light pulses which are emitted or received at different times correspond to different wavelengths λ, with the result that the x-axis also acts as the axis for the wavelength λ.

During this pulsed operation, every light pulse gives a spectral support point ST1, ST2 etc. for the spectrally resolved measurement of the optical properties of the sample. The spectral range that extends from the first first support point ST1 used for the measurement (at time t₁) to the last support point STn (at the time tₙ) is referred to here as the effective spectral range SPE. The wavelength associated with the first support point ST1 (or the associated spectral location of the passage range) is referred to as the initial wavelength, and the wavelength associated with the last support point STn (or the associated spectral location of the passage range) is referred to as the end wavelength. The start of the measurement is at the initial wavelength that corresponds to the first support point ST1 (here 500 nm, for example), and the end of the measurement is reached at the last support point STn (which corresponds to an end wavelength of 690 nm in the case of the example).

An important characteristic of the exemplary embodiment can be seen easily by way of the temporal profile of the motor speed VM. The motor travel of the stepper motor takes place over the entire effective spectral range SPE, i.e. from the initial wavelength to the end wavelength, continuously, specifically in the case of the example at a constant finite movement speed. Before measurement begins, a start-up ramp takes place, during which the motor is accelerated from a standstill (motor speed zero) to the moving speed VS for the spectrum recording. After completion of the measurement, i.e. in time terms after the last support point is reached, comes a braking ramp, during which the motor speed is reduced back to zero.

If, for example, a typical flash operation is assumed at 100 Hz, the recording for example of a fluorescence spectrum over an effective spectral range of 200 nm with a high spectral resolution of 1 nm only takes 2 seconds (2 s).

The spectral resolution can be set by varying the travel speed of the monochromator and/or correspondingly by adapting the flash frequency of the flash lamp. For example, if an overview spectrum is recorded with a spectral resolution of 4 nm, it is possible to record a spectrum over an available spectral range of 200 nm to 1000 nm in only 2 s. Depending on the flash lamp used, higher flash frequencies, for example of up to 500 Hz, can also be used, with the result that such a spectrum can then mathematically be recorded in approximately 400 ms. As can be seen in principle from FIG. 4, relatively short time intervals for the start-up ramp and the braking ramp, e.g. in the order of magnitude of 100 ms, should be added to these values for the effective measurement time.

The spectra recorded in this way theoretically have a slight spectral smear, since the adjustment movement of the dispersive element (one or more) in the monochromator is continued during flashing. However, since typical flash durations are frequently in the order of magnitude of 2 μs, while the dead time at typical frequencies of 100 Hz is around 10 ms, then at a spectral resolution of a theoretical 1 nm, the smear is approximately 0.2 pm, which is negligibly small in most cases or in all practical cases. At larger spectral steps between the support points (and a correspondingly greater travel speed), the smear becomes greater and can increase, for example at a step width of 10 nm, to approximately 2 pm, which can still be considered negligible for most or all cases.

To illustrate differences with respect to the prior art, FIG. 5 shows a schematic diagram of the dependence of the travel path SM of the stepper motor of a tunable monochromator on time in a conventional system with start/stop operation (SdT=prior art). FIG. 6 shows a corresponding diagram in an exemplary embodiment with a continuous change in the spectral location of the spectral passage range due to a constant travel speed. The lightning symbols in each case characterize a flash or a light pulse. In the prior art, the stepper motor is paused in each case before a flash is triggered, and the flash falls into a stopping phase without motor movement (travel path does not change during the resting phase). In methods and systems in accordance with the present application, flashes are triggered with a moving stepper motor and thus a changing spectral location of the passage range.

It can occur in particular in fluorescence measurements that a single flash per spectral support point is not enough for sensitive measurements. In order to address this circumstance, the synchronized spectral scan of a sample can be repeated once or multiple times. The individual spectra obtained during each measurement can then be added accordingly. By adding up the signals of a plurality of flashes for each wavelength or each support point, the measurement statistics can be improved in a similar manner as if a longer measurement time per wavelength were used.

In the exemplary embodiment of FIG. 4, a constant shifting speed of the spectral passage range in the entire effective spectral range SPE of interest is present. This facilitates the synchronization, and in addition the spectra obtained in this manner are directly evaluable in the sense that no corrections with respect to different distances between the spectral support points need to be made.

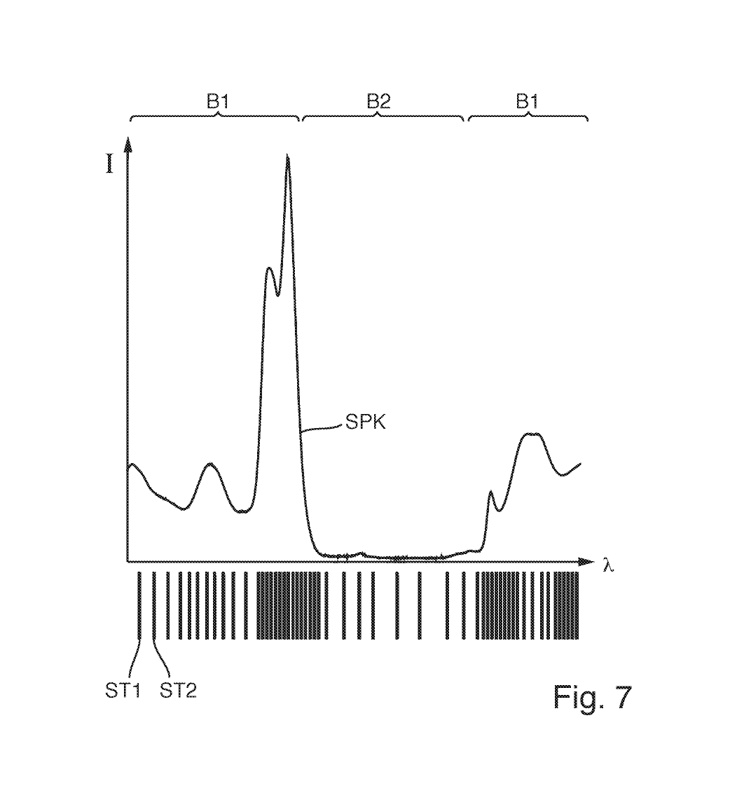

However, it can also be advantageous to change the shifting speed during the continuous shifting within the effective spectral range, but without completely stopping the shifting movement. In this respect, FIG. 7 by way of example illustrates an I(λ) diagram (intensity I as a function of the wavelength λ) with a hypothetical spectrum SPK of a sample substance. In the present case, this can be a characteristic spectrum of a specific substance class, in which relatively strong changes in intensity per wavelength occur in certain spectral ranges B1, while the intensity hardly varies with a varying wavelength in other spectral ranges B2. The measurement can here be carried out such that, in the end, there is a variation in the spectral density of support points ST1, ST2 in dependence on properties of the spectrum for different spectral ranges. The dependence can be such that in ranges with relatively strong changes in intensity per wavelength interval, a relatively high spectral support point density occurs, while in other spectral ranges with relatively smaller changes in intensity (of type B2), a lower support point density or a greater wavelength distance between neighbouring support points is selected. The support point density can be approximately or directly proportional to the absolute value of the first derivation of the function I(λ). With a constant pulse frequency, this can be achieved by way of the travel speed of the stepper motor being controlled such that it is approximately or directly inversely proportional to the absolute value of the first derivation of the function I(λ).

Control can be effected, for example, such that the intensity difference of two successive spectral support points ST(n) and ST(n+1) is ascertained, and the reciprocal value of it serves as a prefactor of a previously specified shifting speed. The change in the spectral passage range per unit time Δk/Δt is thus small for great intensity changes |I(ST(n))−I(ST(n+1)|, and thus the number of spectral support points is directly proportional to the local spectral intensity dynamic of the spectrum.

Using a different number of support points per wavelength interval can also be advantageous for the non-continuous operation, i.e. for the “classical” move-stop-measure operating mode or start/stop operation. It is possible in this case for there to be a variation in the step width between immediately successive stopping positions in different wavelength ranges.

For example, the step width can be varied in dependence on a previously known or a measured property of the spectrum. In a variant with variable step width, an intensity change in the detected light between successive stop positions or spectral support points is ascertained during the shifting of the passage range to the next stop position, and the step width is varied in dependence on the intensity change. As a result, a regulation of the step width in dependence on a measured property of the spectrum can be realized. The regulation can be effected, for example, inversely proportionally such that spectral ranges with relatively strong intensity changes are travelled with relatively smaller step widths and a correspondingly higher support point density, while spectral ranges having fewer events are travelled more quickly, i.e. with greater step widths or lower support point density.

It is also possible that, before recording of a spectrum begins, parameters of a step width variation function are preset, and the step width is controlled in accordance with the step width variation function. Here, the change in the step width can be optimized based on previously known properties of an examined spectrum type.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for the spectrally resolved measurement of optical properties of samples, the method comprising the acts of:
arranging a sample at a measurement position;
generating light using a light source;
transmitting spectral components of the light as excitation light in a first optical path to the sample; and
transmitting light that has been emitted or transmitted by the sample in a second optical path to a detector;
wherein a tunable monochromator is arranged in the first optical path and/or in the second optical path;
recording a spectrum of the emitted or transmitted light over an effective spectral range by shifting a spectral passage range of the tunable monochromator,
wherein
light in the form of light pulses with a specifiable pulse frequency is used;
the spectral passage range of the tunable monochromator is shifted at a shifting speed continuously from an initial wavelength to an end wavelength for recording a spectrum; and
the pulse frequency of the light is synchronized with the shifting speed of the spectral passage range by way of a controller such that a plurality of measurements of the emitted or transmitted light takes place within the effective spectral range at a corresponding plurality of spectral support points.

2. The method according to claim 1, wherein excitation light is radiated onto the sample in the form of light pulses with a specifiable pulse frequency, wherein excitation light in the form of light pulses with a specifiable pulse frequency is generated by way of a pulsed light source.

3. The method according to claim 2, wherein the spectral passage range is shifted continuously at a constant shifting speed from the starting position to the end position.

4. The method according to claim 1, wherein the spectral passage range is shifted continuously at a constant shifting speed from the starting position to the end position.

5. The method according to claim 1, wherein the spectral passage range is shifted at a varying shifting speed from the starting position to the end position, wherein the shifting speed is varied in dependence on at least one property of the spectrum.

6. The method according to claim 5, wherein the spectral passage range is shifted at a varying shifting speed from the starting position to the end position, wherein the shifting speed is varied in dependence on at least one property of the spectrum.

7. The method according to claim 5, wherein an intensity change in the detected light between successive spectral support points is ascertained during the shifting of the passage range, and the shifting speed of the passage range is changed in dependence on the intensity change.

8. The method according to claim 5, wherein, before recording of a spectrum begins, parameters of a speed variation function are preset, and the shifting speed is controlled in accordance with the speed variation function.

9. The method according to claim 5, wherein a control or regulation of the shifting speed is performed inversely proportionally to the intensity change between successive spectral support points such that spectral ranges with relatively strong intensity changes are travelled with a relatively smaller shifting speed and a correspondingly higher density of the support points, and spectral ranges having relatively weaker intensity changes are travelled with relatively greater shifting speed and a lower density of the support points.

10. The method according to claim 7, wherein a control or regulation of the shifting speed is performed inversely proportionally to the intensity change between successive spectral support points such that spectral ranges with relatively strong intensity changes are travelled with a relatively smaller shifting speed and a correspondingly higher density of the support points, and spectral ranges having relatively weaker intensity changes are travelled with relatively greater shifting speed and a lower density of the support points.

11. The method according to claim 8, wherein a control or regulation of the shifting speed is performed inversely proportionally to the intensity change between successive spectral support points such that spectral ranges with relatively strong intensity changes are travelled with a relatively smaller shifting speed and a correspondingly higher density of the support points, and spectral ranges having relatively weaker intensity changes are travelled with relatively greater shifting speed and a lower density of the support points.

12. The method according to claim 1, wherein the recording of a spectrum over the effective spectral range is repeated at least once with the same synchronization of the pulse frequency with the shifting speed of the spectral passage range, and the measurement values obtained for each of the recordings are added in wavelength-correct fashion.

13. A system for spectrally resolved measurement of optical properties of samples, comprising:
a sample holding device for arranging a sample at a measurement position;
a light source for generating light;
a detector;
a control unit;
a first optical path for transmitting spectral components of the light as excitation light to the sample;
a second optical path for transmitting light that has been emitted or transmitted by the sample to the detector;
a tunable monochromator which is controllable by the control unit arranged in the first optical path and/or in the second optical path;
wherein the system is configured to record a spectrum of the emitted or transmitted light over an effective spectral range by shifting a spectral passage range of the tunable monochromator,
wherein
the control unit has an operating mode for recording a spectrum in which the control unit is configured such that:
the system is controlled such that light in the form of light pulses with specifiable pulse frequency is used;
the spectral passage range of the tunable monochromator is shifted at a shifting speed continuously from an initial wavelength to an end wavelength for recording a spectrum; and
the pulse frequency of the light is synchronized with the shifting speed of the spectral passage range by way of a control such that a plurality of measurements of the emitted or transmitted light takes place within the effective spectral range at a corresponding plurality of spectral support points.

14. The system according to claim 13, wherein during the operation mode, the light source is controlled such that excitation light in the form of light pulses with a specifiable pulse frequency is generated.

15. The system according to claim 14, wherein the tunable monochromator is a dispersive monochromator with an adjustable dispersive element, or a tunable filter monochromator, or a tunable interference monochromator.

16. The system according to claim 13, wherein the tunable monochromator is a dispersive monochromator with an adjustable dispersive element, or a tunable filter monochromator, or a tunable interference monochromator.

17. The system according to claim 13, wherein the system is integrated in a multitechnology reader.

18. The system according to claim 14, wherein the system is integrated in a multitechnology reader.

19. The system according to claim 15, wherein the system is integrated in a multitechnology reader.
